(19) United States
(12) Patent Application Publication
(10) Pub. No.: US 2011/0270733 A1
(43) Pub. Date: Nov. 3, 2011

(54) Computer and Network Implemented Money Market Instrument Portal with SWIFT Message Confirmation of Transactions

(75) Inventor: Aron L. Chazen, Menlo Park, CA (US)

(73) Assignee: Treasury Technologies, LLC, Menlo Park, CA (US)

(21) Appl. No.: 13/100,155

(22) Filed: May 3, 2011

Related U.S. Application Data
(60) Provisional application No. 61/330,548, filed on May 3, 2010.

(51) Int. Cl. G06Q 40/00

(52) U.S. Cl. 705/37

(57) ABSTRACT

The present invention relates to a method, system and platform for money market mutual fund purchasing for cash management. In particular, it relates to facilitating book order entry transactions for cash managers that have multiple banking relations and that diversify their cash management by purchasing money market mutual funds from multiple unaffiliated providers. The technology disclosed supports electronically receiving instructions that select among the unaffiliated providers' products, electronically issuing binding orders and binding transfer instructions for settlement, and using SWIFT messages to confirm the transfers to the cash managers. The cash managers' instructions may be received in a variety of forms. In some implementations, this technology is extended to reconcile balances and holdings after execution of the orders and transfers, and to flag any discrepancies.

### RELATED APPLICATION

This application claims the benefit of U.S. Provisional Application No. 61/330,548 filed May 3, 2010, having the same inventor as this non-provisional application and a similar title. The related application is incorporated by reference.

### BACKGROUND OF THE INVENTION

The present invention relates to a method, system and platform for money market mutual fund purchasing (and redemption) for cash management. In particular, it relates to facilitating book order entry transactions for cash managers that have multiple banking relations and that diversify their cash management by purchasing money market mutual funds from multiple unaffiliated providers. The technology disclosed supports electronically receiving instructions that select among the unaffiliated providers' products, electronically issuing binding orders and binding transfer instructions for settlement, and using SWIFT messages to confirm the transfers to the cash managers. The cash managers' instructions may be received in a variety of forms. In some implementations, this technology is extended to reconcile balances and holdings after execution of the orders and transfers, and to flag any discrepancies.

It has long been the practice for sellers of money market mutual funds or investments to interact directly with customers. The treasury or another operating officer of a corporation, state or local government, or financial firm who might want to buy money market mutual funds from 10 sources would call the sources or go to each of their individual websites or software interface packages. Or, the treasury officer might respond to a call from a broker who represents one of the sources. Money market investments that are appropriate for institutional investors are available from diverse sources, but cannot generally be purchased through retail outlets such as Schwab, because the retail outlets primarily lead with their proprietary offerings, which tend to be priced for retail customers (i.e. more expensive and not as competitive). There is a strong incentive for operators of money market investments to lock customers into their product interface and transaction interface, whether the customers are buying directly or through trusted agents.

FIG. 1 depicts the practice described, in which each institution 115 transacts with each fund 133, 137 directly. The funds report to the client in different formats. As for data entry, each fund typically would require manual input to systems of the money market fund provider, the bank 123 and the client's treasury work station (TWS) 127.

FIG. 2 depicts an early system operated by the assignee, which pioneered making money market mutual funds available from multiple money market fund providers via a single GUI. A client's system 215 is used to connect to various systems, including the operator's GUI 221, the client's bank 223 and the client's treasury work station 227. The client's system 215 communicates money market mutual fund trade instructions via the operator's GUI 221 to the operator's system, which sources mutual funds from multiple money market fund providers. Data for trades is used to update the operator's sub accounting platform 231. The client's system 215 independently initiates wire transfers for settlement of the transactions, causing the client's bank 223 to transfer funds on a same-day basis to the operator's custodian (bank, depository, etc.) 233. The operator's custodian, in turn, transfers the funds to the mutual fund's custodian (bank, depository, etc.) 243.

In the FIG. 2 system, the operator groups and reconciles trades. Within a predetermined time window, the operator batches transactions from multiple clients, based on data transferred to the sub accounting platform 231. The operator's system monitors funds received by the operator's custodian 233 from the client's bank 223 and causes funds to be sent from the operator's custodian 233 to the mutual fund's custodian 243. The client's system 215 uses the operator's GUI 221 to access reports. The client's system is used to transfer data from the GUI into the client's spreadsheet, treasury workstation or other cash management tool. Of course, the complementary process of redeeming money market mutual funds with the money market fund provider is also supported, with a complementary flow of information and money.

An opportunity arises to overcome structural impediments and improve systems for purchasing and redeeming money market mutual funds. Better, more easily configured and used, more resilient and transparent systems may result.

### SUMMARY OF THE INVENTION

The present invention relates to a method, system and platform for money market mutual fund purchasing for cash management. In particular, it relates to facilitating book order entry transactions for cash managers that have multiple banking relations and that diversify their cash management by purchasing money market mutual funds from multiple unaffiliated providers. The technology disclosed supports electronically receiving instructions that select among the unaffiliated providers' products, electronically issuing binding orders and binding transfer instructions for settlement, and using SWIFT messages to confirm the transfers to the cash managers. The cash managers' instructions may be received in a variety of forms. In some implementations, this technology is extended to reconcile balances and holdings after execution of the orders and transfers, and to flag any discrepancies. Particular aspects of the present invention are described in the claims, specification and drawings.

### BRIEF DESCRIPTION OF THE DRAWINGS

FIG. 1 depicts sellers of money market mutual funds or investments interacting directly with customers.

FIG. 2 is a high-level block diagram of an early system operated by the assignee, which pioneered making money market mutual funds available from multiple money market fund providers via a single GUI.

FIG. 3 depicts one implementation of the technology disclosed.

FIG. 4 enhances the system in FIG. 3 by extending the operator's use of SWIFT messages to communications with the client's bank's system and the mutual fund's custodian's system.

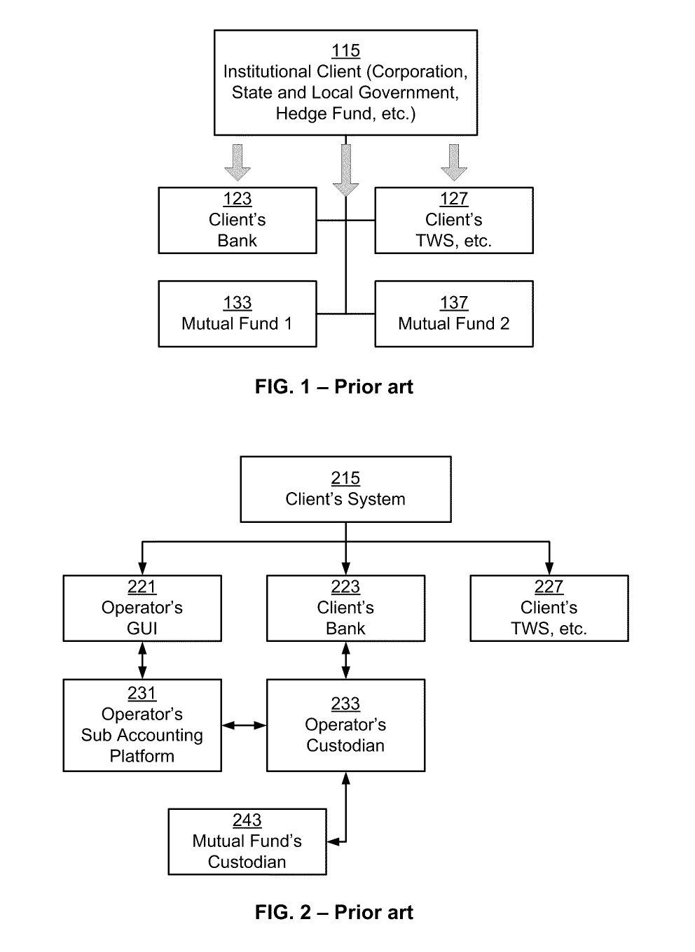

### DETAILED DESCRIPTION

The following detailed description is made with reference to the figures. Preferred embodiments are described to illustrate the present invention, not to limit its scope, which is defined by the claims. Those of ordinary skill in the art will recognize a variety of equivalent variations on the description that follows.

The technology disclosed combines purchasing and/or redemption of money market mutual fund investments from multiple unaffiliated sources with one or more of: (1) interacting with one or more banks that represent a particular client, without preference among banks; (2) providing a service of querying the client's multiple unaffiliated banks at the end of the day and sweeping available funds into client-selected money market mutual funds; and (3) converting mutual fund transaction reports into the SWIFT message format and sending SWIFT messages to the clients, for receipt by their SWIFT-based tools and integration into their SWIFT-based reporting systems. In addition, funds can be re-deposited to appropriate accounts in a timely manner. The sweeps and returns can be implemented using SWIFT messages, which creates great efficiencies for a resource-constrained treasury department and enhances internal controls.

This technology facilitates offering money market mutual funds from multiple sources to cash management clients. It supports same-day purchases and redemptions from multiple sources. The backend, which the broker-dealer operates, collates and matches the requested transactions. Periodically, the system determines how the transactions can be executed and causes them either to be executed electronically or brought to the attention of a person who uses electronic communications to contact the seller and execute the transaction. Due to the broker-dealer's independence, money market mutual funds can be offered from multiple, unaffiliated sources. For instance, funds from competing banks or retail outlets can be offered on the same menu. Fast settlement on a book order entry basis is supported, without the delivery versus payment (DVP) instructed by SWIFT Message Type MT 543m, which is a standard sale transaction type for negotiable securities.

The technology disclosed allows the broker-dealer to interact with one or more banks that represent the client, without any need to prefer one bank or another. A stand-alone software system that is independent of the offering bank can be implemented by the broker-dealer in a way that no bank would consider. A focus on money market fund transactions gives the broker-dealer the option of relying on disclosed fees that the money market funds pay, instead of relying on fees from the clients who are being served. Fees for executing transactions and transferring funds immediately to cover the transactions can be minimized or, potentially, eliminated. One of ordinary skill in the art working for a bank would be unlikely to consider or explore building a system with these characteristics. If they did, they might find themselves unemployed, as the primary advantage of the technology that we describe is to enable customers to be bank-agnostic and to see best-in-class providers besides their primary bank—which is contrary to the interests of their primary bank.

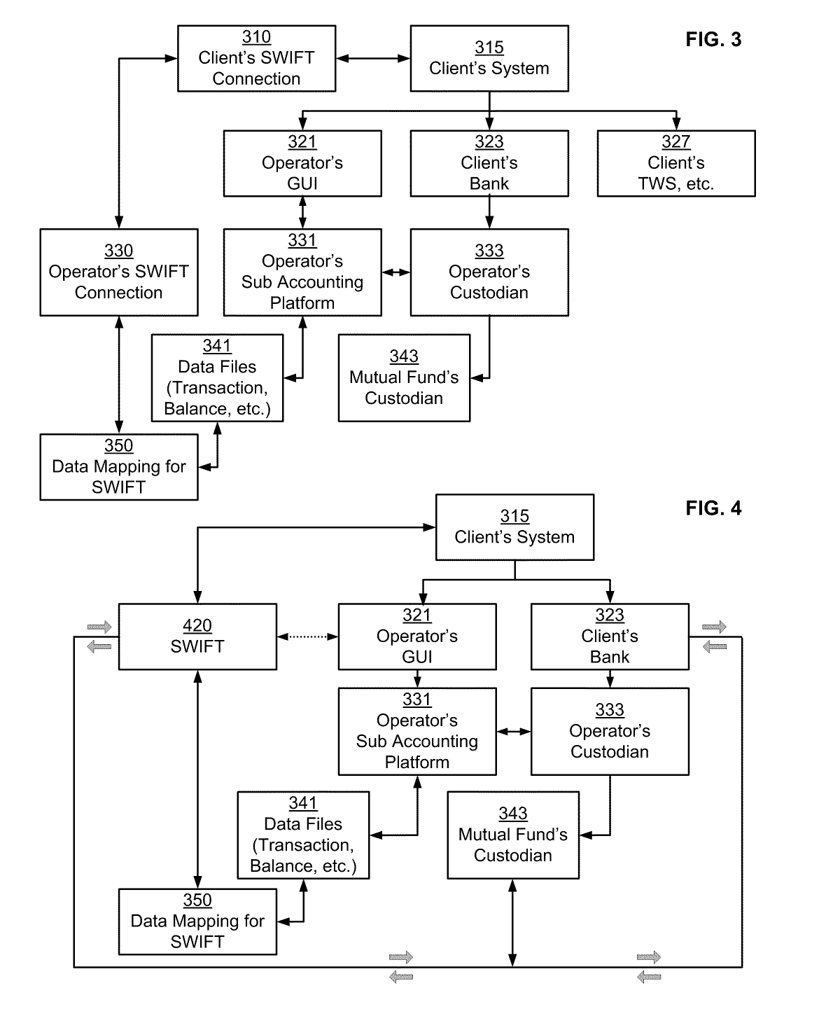

FIG. 3 depicts one implementation of the technology disclosed. The client's system 315 may be a PC, notebook, tablet, work station, server, cluster, mainframe, cloud computing resource or other computer system. The client's system is coupled in communication with a communications channel for delivery of SWIFT messages 310, 330. This channel may be a SWIFT network, an FTP connection, a SOAP carrying channel or other communications channel. The SWIFT messages may be in the format specified by SWIFT's Message Reference Guide or in an XML equivalent. Compliance with SWIFT message format specifications, validation rules, usage rules, field specifications, etc., results in messages that can be recognized by many types of systems with little or no reprogramming of the systems. The client's system 315 is also coupled in communication with the operator's GUI 321, the client's bank system 323 and the client's treasury work station 327 or other accounting tool. In some implementations, the operator provides a graphical user interface for reporting and transactions. The reporting interface may show balances in accounts eligible to be swept into and out of money market funds. Thresholds and differences between balances and thresholds also may be displayed.

For transactions, available money market mutual funds may be displayed. The user can be given the opportunity to select among the funds and choices for how to allocate a purchase amount. The allocation may be expressed as proportions, ceilings, amounts, sequences or other formulas for distribution among the funds. On the purchasing side, sweeping of funds may be driven by preset or adjustable thresholds. Or, amounts to be allocated may be manually entered. On the redemption side, thresholds may represent the replenished balance of various accounts, after redemption. Or, replenished balances can be set. The selection of funds to redeem may be driven by any of the rule or manual entry approaches described, based either on desired balances after replenishment or on desired money market mutual fund holdings after redemption.

Alternatively, for transactions, the client's system 315 could send messages directly to the operator's sub accounting platform 331 on an automated basis, without reliance on the operator's GUI 321. The messages could be sent in SWIFT format, XML format (i.e., appropriate to a web services interface), or via an operator-supplied application program interface. The same reporting information regarding available money market mutual funds could be sent by the operator to the client in SWIFT format, XML format (i.e., appropriate to a web services interface), or via an operator- or client-supplied application program interface. In some instances, the client's treasury work station 327 will be programmed to generate instructions to the operator's sub accounting platform 331 without need for a GUI 321.

In the FIG. 3 implementation, the client's system 315 remains responsible for instructing the client's bank's system 323. The client's bank 323 transfers funds to or receives funds from the operator's custodian 333. The operator's sub accounting platform 331 electronically monitors funds deposited to and withdrawn from the operator's custodian accounts 333. It also instructs the operator's custodian's system 333 to transfer funds to and receive funds from the mutual fund's custodian's system 343.

The operator's sub accounting platform 331 generates data files, such as transaction and balance files 341, for transmission back to the client's system 315. Transaction and balance files 341 are translated by data mapping 350 into SWIFT messages, such as messages MT 335 and MT 336, for transmission 330, 310 or into an XML format compatible with the client's system 315.

The technology disclosed further includes converting mutual fund transaction reports into a consistent format for use by the client reporting systems. Formats have been developed to report execution of money market fund purchases and sales via the so-called SWIFT system. See, SWIFT.com, e.g., messages MT 535 and MT 536. This is an innovative use of banking infrastructure that typically has been used by banks and large corporate treasury departments, but not for reporting daily transactions in money market funds, and not for initiating purchases and redemptions in money market funds. Creating SWIFT messages to report money market fund transactions allows these transactions to be consolidated with other treasury department reports that are derived from SWIFT messages. Systems and users can reconcile balances across diverse accounts based on messages from a single message stream that includes both banking transactions and money market fund transactions. Early indications are that this consolidation is considered unique by the industry and will be very well received.

The technology disclosed may further allow the broker-dealer or operator to provide a coordinated service for querying multiple banks, any one of which may or may not currently be the client's primary bank, to provide automated money management. For instance, threshold criteria can be programmed into the broker-dealer's computer system and cause funds to be swept from accounts in multiple banks that represent the client into overnight money market funds. The program coordinates querying the multiple banks for account balances and ordering transfers from the banks into one or more money market funds selected by the client from the multiple sources offered. The program can perform these queries at predetermined times which may be coordinated with time zones, bank clearing practices, and business operation hours across the country or around the world. Programmed queries and trades at predetermined times are less onerous and more reliable than having a treasury assistant perform the same task.

The technology disclosed expands on this approach by authorizing fund transfers to cover transactions and/or by providing sub accounting services to reconcile the balances across diverse accounts, saving the clients the need to program their systems to carry out these functions. In some implementations, the technology disclosed could receive the client's instructions for selection of money market funds, automatically determine the amount of funds available for the purchase, cause electronic messages to be executed for purchase of the funds and also generate SWIFT messages instructing the client's banks to transfer funds to cover the money market fund purchases. That is, the system will automatically generate binding messages to which the banks respond by sending money, same-day and before the close of the market, to accounts belonging to the money market funds selected by the client. Unlike a traditional retail account, it will not be necessary for funds to be on deposit with the particular bank, in order to support same-day settlement of transfers. The technology disclosed allows the broker-dealer to be bank-agnostic as to the source and destination of funds that are transferred on a daily basis into and out of money market funds. The simple threshold requirement for participation is that these transactions will be with the banks participating in the SWIFT system, which is easily met. It is not necessary for the operators of the money market funds to be SWIFT participants, as long as their banks participate.

FIG. 4 enhances the system in FIG. 3 by extending the operator's use of SWIFT messages to communications with the client's bank's system 323 and the mutual fund's custodian's system 343. This extension facilitates displaying client bank account balances via the operator's GUI 321, because standard SWIFT messages include account balance queries.

Our technology further provides sub accounting services that perform reconciliation between the client, their bank and the mutual fund's bank, which clients may otherwise decide to program their SWIFT message handling systems to perform. The broker-dealer would receive confirmation messages from banks that executed transfers. The broker-dealer would reconcile responses to balance queries and confirmations of money movement with orders placed to buy and sell money market funds. The sub accounting system would reconcile reports from various sources and confirm to the client that funds were safely on account where they were expected to be. Automated reconciliation of money market fund purchases and redemptions using messages received through SWIFT is a new service that becomes available once the sub accounting platform is in place. At present, transaction channels are so scattered and reporting so uncoordinated that manual reconciliations using a spreadsheet are typical.

Using this technology, the problem of managing cash on deposit with multiple unaffiliated banks, potentially in different countries, is addressed using a single platform with an integrated interface that allows a treasury officer to select among money market instruments independent of any seller, with so-called straight-through processing. By straight-through processing, we mean that a cash management client places a trade with the operator and does not need to go to a second platform to handle settlement funds transfer. The operator has stored instructions and authorizations to act on behalf of the client to issue binding orders and transfer instructions, which the operator transmits. The operator confirms the orders and transfers (and, optionally, resulting balances) in a format that can be automatically loaded into the client's treasury work station, spreadsheet, or other cash management platform.

This solution may be enhanced by the platform automatically using SWIFT messages to cause settlement of the money market instrument purchases from the client's multiple unaffiliated banks to one or more money market instrument sellers, selected by the treasury officer.

Another enhancement, used in any combination with the previously described technology, involves the treasury officer setting automated sweep instructions, which the platform executes periodically, such as hourly, and at the end of the day, but before the close of the market for making same-day investments. The sweep instructions by the platform may be executed using a SWIFT query message for the balance of accounts subject to the instructions, comparing the query results to the instructions, and buying money market instruments and settling the purchases. While the process is entirely automated to the client treasury officer, it should be understood that purchases may be batched for multiple customers or periodic execution and that the messaging technology may be fully automated or as simple as a telephone call.

We further anticipate enhancing this technology with a sub accounting and reconciliation service. Sub accounting would indicate by bank and bank group, for instance, and by money market instrument issuer the location and flow of funds on a daily, hourly or on-demand basis. Sub accounting also could support client sub accounts, such as a public sector client having sub accounts for a park district, parking meter revenue, etc. Reconciliation would match reported results from banks, instrument issuers, etc., with expected results of transaction orders. Tracking and reconciliation across unaffiliated banks and multiple instrument issuers would be centralized and automated.

A related problem of low-cost support for moving money from banks to money market instruments, to implement sweeps using money market instruments with favorable interest rates that are not sold by the banks involved, is addressed using a single platform with an integrated interface that allows a treasury officer to select among money market instruments independent of any seller, with so-called straight-through processing by the platform, to cause execution of the desired purchases and confirmation of the transactions via SWIFT messages that are readily integrated into treasury reporting. The service's independence reduces the temptation to charge captive audience rates. Use of SWIFT messages and protocols reduces the operator's cost to a fraction of the amount that banks typically charge in fees. Concentration on money market instruments creates a disclosed opportunity to have the money market issuers carry much of the cost of operating the portals.

### Some Particular Embodiments

The technology disclosed may be practiced as a method, a system specially programmed to practice the method, or an article of manufacture, such as a non-transitory computer-readable storage medium with method or device computer program instructions. The same method can be viewed from the perspective of the operator or the client. In the following section, methods and systems are described from the perspective of the operator. The same methods and systems can be understood from this description from the perspective of the client, without need for repeated prose.

One method implementation is a computer-implemented method of supporting cash management. This method includes executing a plurality of money market mutual fund purchases on a book order entry basis for a cash management client. Cash management clients may include corporate treasury departments, pension operation, government general fund management, etc. The funds typically addressed for cash management are operating cash and short-term cash on the balance sheet. The method further includes confirming transactions (and, optionally, resulting balances) via SWIFT messages. The SWIFT messages can be translated by the operator into XML format, or can be translated by the operator or client into any desired internal format. It is expected that clients will have translators available to translate incoming SWIFT messages into their desired format. Clients that do not subscribe to the SWIFT network may nonetheless accept SWIFT messages via FTP or other messaging protocol. The SWIFT messages confirm to the cash management client transfers between depositories holding funds for the cash management client and money market fund providers, resulting from client instructions.

In some implementations, the executing and confirming described above include electronically receiving from the cash management client instructions to purchase certain money market mutual funds from a plurality of unaffiliated money market sellers and to draw settlement funds against certain account balances at one or more unaffiliated depositories. We refer to the money market fund providers as unaffiliated because the method described is not captive to any particular fund provider (though aspects of the method could be adopted by a fund provider, particularly one that was willing to sell competitors' products). Receiving instructions can be followed by electronically issuing binding orders to purchase the certain money market mutual funds on behalf of the cash management client and binding transfer instructions against the client's accounts to settle the mutual fund purchases. The confirming described above may include sending one or more SWIFT messages to the cash management client confirming the resulting transfers (and, optionally, resulting balances) between the depositories and the money market fund providers. Translation and transport options mentioned above also apply here.

This method can be extended by receiving from the cash management client instructions that include thresholds for the account balances, above which funds are scheduled to be swept periodically, for instance overnight, into selected money market mutual funds. In addition or separately, the cash management client instructions may include how to apportion purchases among selected money market mutual funds. When balance thresholds are combined with apportionment rules, the system can run automatically according to a predetermined schedule. It can issue binding orders and binding transfer instructions to sweep funds above the thresholds into the selected money market mutual funds with little or no daily intervention.

Another aspect of this method includes electronically collecting account balances from the plurality of unaffiliated depositories for the cash management client. These balances may be reported via the same GUI as used to report money market mutual fund pricing information, either on separate screens or tabs, or in a consolidated display. Collecting balances may optionally be combined with receiving balance threshold instructions. When both are available, the GUI can be used to report margins by which the account balances exceed the thresholds.

A further aspect of this method includes, after issuing the binding orders and the binding transfer instructions, issuing queries to the depositories for account balances and to the money market fund providers for fund holdings. These queries result in electronically collecting the account balances and fund holdings, which can be forwarded to the client via one or more SWIFT messages. With balances in hand, the operator's sub accounting platform may reconcile the account balances and the fund holdings with the binding orders and transfer instructions and flag any discrepancies for follow-up.

Client instructions may be received via a SWIFT or XML message, both for this purchase-oriented method and for the following redemption method. These instructions may be responsive to the operator's system having sent the client account balances and money market mutual fund pricing information. Or, the client's treasury work station may be programmed to collect balance and pricing information independently, optionally with the operator's technical assistance.

Another computer-implemented method of supporting treasury cash management redeems money market mutual fund investments, instead of purchasing them. The redemption method and its aspects and options are complementary to the purchasing method described above. This method includes executing a plurality of money market mutual fund redemptions on a book order entry basis for a cash management client. The method further includes confirming transactions (and, optionally, resulting balances) via SWIFT messages. Options, alternatives, aspects and features of the purchasing method apply to the redemption method and are incorporated by reference as if repeated with appropriate adaptations.

In some implementations, the executing and confirming above include electronically receiving from the cash management client instructions to redeem certain money market mutual funds from a plurality of unaffiliated money market sellers and to have settlement funds directed to certain client accounts at one or more unaffiliated depositories. Receiving instructions can be followed by electronically issuing binding orders to redeem the certain money market mutual funds on behalf of the cash management client and binding transfer instructions specifying the client's accounts into which redemption funds should be deposited. The confirming above may include sending one or more SWIFT messages to the cash management client confirming the resulting transfers (and, optionally, resulting balances) between the depositories and the money market fund providers. Translation and transport options mentioned above also apply here.

This method can be extended by receiving from the cash management client instructions that include thresholds for the account balances, below which funds are scheduled to be replenished periodically from selected money market mutual funds. In addition or separately, the cash management client instructions may include how to apportion redemptions among selected money market mutual funds. When balance thresholds are combined with apportionment rules, the system can run automatically according to a predetermined schedule. It can issue binding orders and binding transfer instructions to redeem funds and replenish accounts that are below the thresholds from the selected money market mutual funds with little or no daily intervention.

Another aspect of this method includes electronically collecting account balances from the plurality of unaffiliated depositories for the cash management client. These balances may be reported via the operator's GUI, either on separate screens or tabs, or in a consolidated display. Collecting balances may optionally be combined with receiving balance threshold instructions. When both are available, the GUI can be used to report margins by which the account balances are below the replenishment thresholds. Collecting account balances may be combined with reconciling account balances and fund holdings with redemptions and transfer instructions, as described for purchase instructions.

Any of the methods described above may be practiced by a computer system that supports treasury cash management. In general, such systems are specially programmed to carry out the methods described. Such a system includes a processor, memory coupled to the processor and a network connection coupled to the processor. The computer program instructions execute on the processor and cause the system to implement the methods described. For instance, the computer instructions in one implementation execute a plurality of money market mutual fund purchases on a book order entry basis for a cash management client and confirm via SWIFT messages to the cash management client resulting transfers between depositories holding funds for the cash management client and money market fund providers. In another implementation, the computer instructions execute a plurality of money market mutual fund redemptions on a book order entry basis for a cash management client. The computer program instructions further confirm transactions (and, optionally, resulting balances) via SWIFT messages. Options, alternatives, aspects and features of the purchasing and redemption methods can be implemented by the computer program instructions and are incorporated by reference as if repeated with appropriate adaptations.

In some implementations, the computer program instructions cause the system to electronically receive from the cash management client instructions to purchase and/or redeem certain money market mutual funds from a plurality of unaffiliated money market sellers and to have purchase and/or settlement funds transferred from or to certain client accounts at one or more unaffiliated depositories. Receiving instructions can be followed by electronically issuing binding orders and binding transfer instructions. The system may send one or more SWIFT messages to the cash management client confirming the resulting transfers (and, optionally, resulting balances.) Translation and transport options mentioned above in the context of methods also apply to the systems.

As described more fully in the context of the methods, the systems may accept the cash management client instructions that include sweep and/or redemption thresholds for the account balances above or below which funds are scheduled to be periodically swept to or redeemed from selected money market mutual funds. These client instructions may include rules for how to apportion sweeps and redemptions among the selected money market mutual funds. The computer instructions may issue binding orders and binding transfer instructions automatically according to a predetermined schedule.

As described more fully in the context of the methods, the computer program instructions further may cause the system to electronically collect account balances from the plurality of unaffiliated depositories for the cash management client. The system may report these balances via the operator's GUI, either on separate screens or tabs, or in a consolidated display. System collection of balances may optionally be combined with receipt of balance threshold instructions. When both are available, the GUI can be used to report margins by which the account balances are above or below sweep or replenishment thresholds. Collecting account balances may be combined with reconciling account balances and fund holdings with orders and/or redemptions, and with transfer instructions.

The technology disclosed may further be practiced as articles of manufacture that include computer-readable, non-transitory storage media that holds computer program instructions. In some implementations, the computer program instructions, when loaded onto appropriate hardware, carry out any of the methods described. In other implementations, the computer program instructions, when combined with appropriate hardware, produce any of the systems described.

We claim as follows:

1. A computer-implemented method of supporting cash management, the method including:
executing a plurality of money market mutual fund purchases on a book order entry basis for a cash management client and confirming via SWIFT messages to the cash management client resulting transfers between depositories holding funds for the cash management client and money market fund providers, comprising:
electronically receiving from the cash management client instructions to purchase certain money market mutual funds from a plurality of unaffiliated money market sellers and to draw settlement funds against certain account balances at a plurality of unaffiliated depositories;
electronically issuing on behalf of the cash management client binding orders to purchase the certain money market mutual funds and binding transfer instructions against the certain account balances to settle the purchase of the certain money market mutual funds; and
sending one or more SWIFT messages to confirm to the cash management client the resulting transfers between the depositories and the money market fund providers.

2. The method of claim 1, wherein:
the cash management client instructions to draw settlement funds include thresholds for the account balances above which funds are scheduled to be swept periodically into selected money market mutual funds;
the cash management client instructions to purchase the certain money market mutual funds give rules for how to apportion the account balances above the thresholds among the selected money market mutual funds; and
the binding orders and the binding transfer instructions are automatically issued according to a predetermined schedule to sweep the funds above the thresholds into the selected money market mutual funds.

3. The method of claim 1, wherein the SWIFT messages are sent via the SWIFT network.

4. The method of claim 1, further including:
electronically collecting on behalf of the cash management client account balances from the plurality of unaffiliated depositories;
electronically collecting money market mutual fund pricing information from the plurality of unaffiliated money market fund providers; and
sending the cash management client the account balances and the money market mutual fund pricing information.

5. The method of claim 4, further including:
storing for the cash management client thresholds for the account balances above which funds will be swept overnight into selected money market mutual funds; and
wherein the sending the cash management client the account balances further includes reporting margins by which the account balances exceed the thresholds.

6. The method of claim 1, further including:
after the issuing of the binding orders and the binding transfer instructions, issuing queries to the depositories for account balances and to the money market fund providers for fund holdings, and electronically collecting and forwarding via one or more SWIFT messages the account balances and fund holdings.

7. The method of claim 6, further including:
after the electronically collecting, reconciling the account balances and the fund holdings with the binding orders and the binding transfer instructions and flagging any discrepancies for follow-up.

8. The method of claim 1, wherein the cash management client instructions are received via a SWIFT or XML message.

9. The method of claim 4, wherein the cash management client instructions are received in response to the sending the cash management client the account balances and the money market mutual fund pricing information.

10. A computer-implemented method of supporting treasury cash management, the method including:
executing a plurality of money market mutual fund redemptions on a book order entry basis for a cash management client and confirming via SWIFT messages to the cash management client resulting transfers between money market fund providers and depositories receiving funds for the cash management client, comprising:
electronically receiving from the cash management client instructions to redeem certain money market mutual funds held by a plurality of unaffiliated money market providers and for settlement funds to be deposited to certain accounts at a plurality of unaffiliated depositories;
electronically issuing on behalf of the cash management client binding orders to redeem the certain money market mutual funds and binding transfer instructions for the settlement funds to be deposited to the certain accounts; and
sending one or more SWIFT messages via the SWIFT network to confirm to the cash management client the resulting transfers between the money market fund providers and the depositories.

11. The method of claim 10, further including:
electronically collecting on behalf of the cash management client account balances from the plurality of unaffiliated depositories;
electronically collecting money market mutual fund redemption information from the plurality of unaffiliated money market fund providers; and
sending the cash management client the account balances and the money market mutual fund redemption information.

12. The method of claim 10, further including:
after the issuing the binding orders and the binding transfer instructions, issuing queries to the depositories for account balances and to the money market fund providers for fund holdings, and electronically collecting and forwarding via one or more SWIFT messages the account balances and fund holdings.

13. The method of claim 12, further including:
after the electronically collecting, reconciling the account balances and the fund holdings with the binding orders and the binding transfer instructions and flagging any discrepancies for follow-up.

14. A computer system that supports treasury cash management, the system including:
a processor, memory coupled to the processor and a network connection coupled to the processor; and
computer program instructions executing on the processor that execute a plurality of money market mutual fund purchases on a book order entry basis for a cash management client and confirm via SWIFT messages to the cash management client resulting transfers between depositories holding funds for the cash management client and money market fund providers, wherein the computer program instructions cause the system to:
electronically receive from the cash management client instructions to purchase certain money market mutual funds from a plurality of unaffiliated money market sellers and to draw settlement funds against certain account balances at a plurality of unaffiliated depositories;
electronically issue on behalf of the cash management client binding orders to purchase the certain money market mutual funds and binding transfer instructions against the certain account balances to settle the purchase of the certain money market mutual funds; and
send one or more SWIFT messages via the SWIFT network to confirm to the cash management client the resulting transfers between the depositories and the money market fund providers.

15. The system of claim 14, wherein:
the cash management client instructions to draw settlement funds include thresholds for the account balances above which funds are scheduled to be swept periodically into selected money market mutual funds;
the cash management client instructions to purchase the certain money market mutual funds give rules for how to apportion the account balances above the thresholds among the selected money market mutual funds; and
the binding orders and the binding transfer instructions are automatically issued by the system according to a predetermined schedule to sweep the funds above the thresholds into the selected money market mutual funds.

16. The system of claim 14, wherein the computer program instructions further cause the system to:
electronically collect on behalf of the cash management client account balances from the plurality of unaffiliated depositories;
electronically collect money market mutual fund pricing information from the plurality of unaffiliated money market fund providers; and
send the cash management client the account balances and the money market mutual fund pricing information.

17. The system of claim 16, wherein the computer program instructions further cause the system to:
store thresholds for the account balances above which funds will be swept periodically into selected money market mutual funds; and
send the cash management client the account balances further including a report of margins by which the account balances exceed the thresholds.

18. A computer system that supports treasury cash management, the system including:
a processor, memory coupled to the processor and a network connection coupled to the processor; and
computer program instructions executing on the processor that execute a plurality of money market mutual fund redemptions on a book order entry basis for a cash management client and confirm via SWIFT messages to the cash management client resulting transfers between money market fund providers and depositories holding funds for the cash management client, wherein the computer program instructions cause the system to:
electronically receive from the cash management client instructions to redeem certain money market mutual funds from a plurality of unaffiliated money market sellers and for settlement funds to be deposited to certain account balances at a plurality of unaffiliated depositories;
electronically issue on behalf of the cash management client binding orders to redeem the certain money market mutual funds and binding transfer instructions for the settlement funds to be deposited to the certain account balances; and
send one or more SWIFT messages via the SWIFT network to confirm to the cash management client the resulting transfers between the money market fund providers and the depositories.

19. The system of claim 18, wherein the computer program instructions further cause the system to:
electronically collect on behalf of the cash management client account balances from the plurality of unaffiliated depositories;
electronically collect money market mutual fund redemption information from the plurality of unaffiliated money market fund providers; and
send the cash management client the account balances and the money market mutual fund redemption information.

20. The system of claim 19, wherein the computer program instructions further cause the system to:
store thresholds for the account balances to be established by redeeming money market mutual funds on a periodic basis; and
send the cash management client the account balances further including a report of margins by which the account balances need to be increased to meet the thresholds.
